(19) United States
(12) Patent Application Publication
(10) Pub. No.: US 2004/0032620 A1
(43) Pub. Date: Feb. 19, 2004

(54) Printing apparatus, information processing apparatus, printing system, control method for them, and program

(76) Inventors: Souhei Tanaka, Kanagawa (JP); Masafumi Wataya, Kanagawa (JP); Akira Kuronuma, Tokyo (JP); Toru Nakayama, Kanagawa (JP); Takuji Katsu, Kanagawa (JP)

Correspondence Address: MORGAN & FINNEGAN, L.L.P., 345 PARK AVENUE, NEW YORK, NY, 10154, US

(21) Appl. No.: 10/639,356

(22) Filed: Aug. 12, 2003

(30) Foreign Application Priority Data
Aug. 12, 2002 (JP) 2002-234724

(51) Int. Cl. G06F 3/12; G06F 15/00; G06K 15/02; G06F 13/00

(52) U.S. Cl. 358/1.16; 358/502

(57) ABSTRACT

Printing data containing a flag representing the type of printing mode is input from a host computer via an interface. An MPU selects either of print buffer 1 and print buffer 2 as a storage destination serving as a printing data holding destination on the basis of the flag in the input printing data that represents the type of printing mode. The printing data is stored in the selected storage destination. The stored printing data is transferred to a printhead.

### FIELD OF THE INVENTION

The present invention relates to a printing apparatus having a printhead constituted by arraying printing elements which print in the same color in a printing medium convey direction and correspond to different printing dot diameters, an information processing apparatus which is connected to the printing apparatus, and a printing system comprised of the printing apparatus and information processing apparatus.

### BACKGROUND OF THE INVENTION

Printing by a serial printer using an ink-jet method or the like requires a print buffer which stores printing data by at least one main scanning before printing. In recent years, a printhead which is constituted to increase the printing resolution or form printing dots in different sizes and has a plurality of types of ink orifice groups tends to require a larger-capacity print buffer along with an increase in the number of ink orifices.

For example, in a conventional color printer apparatus using a printhead 11 as shown in FIG. 7, reference numeral 12a denotes an array of first, third, fifth, . . . , 125th, and 127th odd-numbered nozzles which discharge black ink; and 12b, an array of second, fourth, sixth, . . . , 126th, and 128th even-numbered nozzles which discharge black ink. A blank ink orifice 16 has a size for discharging 30 pl of ink at once. A distance a between adjacent ink orifices on the same nozzle array is 1/300 inches. A distance b between adjacent ink orifices on different nozzle arrays is 1/600 inches.

Similarly, reference numerals 13a and 13b denote cyan nozzle arrays; 14a and 14b, magenta nozzle arrays; and 15a and 15b, yellow nozzle arrays. Each color nozzle array comprises an ink orifice 17 which discharges 5 pl of ink. The distance a between adjacent ink orifices on the same nozzle array is 1/300 inches, similar to the black nozzle array. Also, the distance b between adjacent ink orifices on different nozzle arrays is 1/600 inches.

In highest-quality printing in the use of the printhead 11, the black printhead can print in a 1/600″ square with a maximum amount of 60 pl of ink which is double larger than 30 pl of ink. The color printhead can print in a 1/600″ square for each color with a maximum amount of 20 pl of ink which is four times larger than 5 pl of ink. At this time, black ink has three tone levels, and color ink has five tone levels.

The printhead 11 completes printing in a predetermined printing region by a plurality of (e.g., four) main scanning operations.

A print buffer capacity necessary to form an image for four main scanning operations by the printhead 11 at an 8″ width is

| | | | Number of | Number of | Number | Memory capa- |
|---|---|---|---|---|---|---|
| | Dpi | Inch | nozzles | arrays | of dots | city [bits] |
| Black | 600 × | 8 × | 64 × | 2 × | 2 = | 1,228,800 (1) |
| head: | | | | | | |
| (30 pl) | | | | | | |
| Color | 600 × | 8 × | 64 × | 6 × | 4 = | 7,372,800 (2) |
| head: | | | | Total | = | 8,601,600 (3) |
| (5 pl) | | | | | | |

In practice, a data mapping wait time is generated every main scanning unless data of the next scanning is mapped in the print buffer during one main scanning. Since an image is completed by ¼ by one main scanning of the printhead 11, a larger-capacity print buffer is prepared for a necessary memory capacity:

8,601,600×1.25=10,752,000 bits (4)

The current printing apparatus moves within the printing section by a width of about 8 inches at a main scanning rate of 25 inches/sec. One main scanning ends within about 0.5 sec including prescanning, the deceleration time, and the reversal stop time. In order to transfer data (2,150,400 bits) which is ¼ of a total of 8,601,600 bits during one main scanning, a necessary interface transfer rate for one main scanning time of 0.5 sec is

8,601,600÷4÷0.5=4,300,800 bits/sec (537.6 kbytes/sec) (5)

This transfer rate is slightly higher than the transfer rate (maximum effective data transfer rate of about 500 kbytes/sec) of an IEEE 1284 ECP mode which is generally used in a printer, and can only be achieved by the transfer rate of a USB interface which is recently adopted more and more.

However, when the number of printhead nozzle arrays is increased to realize finer tonal expression, the print buffer capacity must be increased or an increase in transfer data rate must be decreased in the conventional arrangement.

### SUMMARY OF THE INVENTION

The present invention has been made to overcome the conventional drawbacks, and has as its object to provide a printing apparatus capable of suppressing an increase in print buffer capacity and efficiently printing by using an existing interface, an information processing apparatus, a printing system, a control method for them, and a program.

According to the present invention, the foregoing object is attained by providing a printing apparatus which performs printing by using a printhead having a nozzle array on which nozzles for discharging a first droplet amount of ink are arrayed and a nozzle array on which nozzles for discharging a second droplet amount of ink are arrayed, comprising: input means for inputting printing data containing a flag representing a type of printing mode from an external device; scanning means for scanning the printhead in a direction different from a nozzle array direction; a plurality of storage means for temporarily holding the printing data input by the input means; control means for selecting storage means serving as a holding destination for the printing data from the plurality of storage means on the basis of the flag in the printing data that represents the type of printing mode, and storing the printing data in the selected storage means; and transfer means for transferring the printing data stored in the storage means to the printhead.

In a preferred embodiment, the type of printing mode includes at least a single-pass printing mode and a multipass printing mode, flags representing the respective printing modes include first and second flags, and the plurality of storage means include at least first storage means for storing first printing data for the single-pass printing mode and second storage means for storing second printing data for the multipass printing mode.

In a preferred embodiment, the plurality of storage means further comprise a reception buffer which receives the printing data input by the input means, and a work buffer for converting the printing data stored in the reception buffer into printhead printing data, and the first and second printing data respectively correspond to the printhead printing data converted in the work buffer.

In a preferred embodiment, when the flag in the printing data stored in the reception buffer is the first flag, the control means directly stores the printing data as the first printing data in the first storage means.

In a preferred embodiment, the printhead includes an ink-jet printhead which discharges ink to perform printing.

In a preferred embodiment, the printhead includes a printhead which discharges ink by using heat energy, and comprises a thermal transducer for generating heat energy to be applied to ink.

In a preferred embodiment, the printhead includes a color printhead in which printing element groups each including a plurality of printing elements are arrayed by a number corresponding to the number of printing agents in a plurality of colors in the scanning direction of the scanning means in correspondence with the printing agents in the plurality of colors.

According to another aspect of the present invention, the foregoing object is attained by providing an information processing apparatus which generates printing data to be output to a printing apparatus, comprising: generation means for generating printing data containing a flag representing a type of printing mode used for printing by the printing apparatus; and output means for outputting the printing data generated by the generation means to the printing apparatus, wherein the printing apparatus performs printing by using a printhead having a nozzle array on which nozzles for discharging a first droplet amount of ink are arrayed, and a nozzle array on which nozzles for discharging a second droplet amount of ink are arrayed.

In still another aspect of the present invention, the foregoing object is attained by providing a printing system constituted by connecting an information processing apparatus and a printing apparatus via a predetermined interface, wherein the information processing apparatus comprises: generation means for generating printing data containing a flag representing a type of printing mode used for printing by the printing apparatus; output means for outputting the printing data generated by the generation means to the printing apparatus; and input means for inputting the printing data containing the flag representing the type of printing mode from an external device, and the printing apparatus comprises: input means for inputting the printing data from the information processing apparatus; printing means for performing printing by using a printhead having a nozzle array on which nozzles for discharging a first droplet amount of ink are arrayed, and a nozzle array on which nozzles for discharging a second droplet amount of ink are arrayed; scanning means for scanning the printhead in a direction different from a convey direction; a plurality of storage means for temporarily holding the printing data input by the input means; control means for selecting storage means serving as a holding destination for the printing data from the plurality of storage means on the basis of the flag in the printing data that represents the type of printing mode, and storing the printing data in the selected storage means; and transfer means for transferring the printing data stored in the storage means to the printhead.

In still another aspect of the present invention, the foregoing object is attained by providing a method of controlling a printing apparatus having a printhead with a nozzle array on which nozzles for discharging a first droplet amount of ink are arrayed, and a nozzle array on which nozzles for discharging a second droplet amount of ink are arrayed, comprising: an input step of inputting printing data containing a flag representing a type of printing mode from an external device; a scanning step of scanning the printhead in a direction different from a convey direction; a control step of selecting a storage unit serving as a holding destination for the printing data from a plurality of storage units on the basis of the flag in the printing data that represents the type of printing mode, and storing the printing data in the selected storage unit; and a transfer step of transferring the printing data stored in the storage unit to the printhead.

In still another aspect of the present invention, the foregoing object is attained by providing an information processing method of generating printing data to be output to a printing apparatus, comprising: a generation step of generating printing data containing a flag representing a type of printing mode used for printing by the printing apparatus; and an output step of outputting the printing data generated in the generation step to the printing apparatus, wherein the printing apparatus performs printing by using a printhead having a nozzle array on which nozzles for discharging a first droplet amount of ink are arrayed, and a nozzle array on which nozzles for discharging a second droplet amount of ink are arrayed.

In still another aspect of the present invention, the foregoing object is attained by providing a program which causes a computer to control a printing apparatus having a printhead with a nozzle array on which nozzles for discharging a first droplet amount of ink are arrayed, and a nozzle array on which nozzles for discharging a second droplet amount of ink are arrayed, comprising: a program code for an input step of inputting printing data containing a flag representing a type of printing mode from an external device; a program code for a scanning step of scanning the printhead in a direction different from a convey direction; a program code for a control step of selecting a storage unit serving as a holding destination for the printing data from a plurality of storage units on the basis of the flag in the printing data that represents the type of printing mode, and storing the printing data in the selected storage unit; and a program code for a transfer step of transferring the printing data stored in the storage unit to the printhead.

In still another aspect of the present invention, the foregoing object is attained by providing a program which causes a computer to perform information processing for generating printing data to be output to a printing apparatus, comprising: a program code for a generation step of generating printing data containing a flag representing a type of printing mode used for printing by the printing apparatus; and a program code for an output step of outputting the printing data generated in the generation step to the printing apparatus, wherein the printing apparatus performs printing by using a printhead having a nozzle array on which nozzles for discharging a first droplet amount of ink are arrayed, and a nozzle array on which nozzles for discharging a second droplet amount of ink are arrayed.

In a preferred embodiment, the control means rewrites all printing data stored in the first storage means every scanning printing in the single-pass printing mode, and rewrites some of printing data stored in the second storage means every scanning printing in the multipass printing mode.

In a preferred embodiment, the first storage means stores printing data for discharging the first droplet amount of ink, and the second storage means stores printing data for discharging the second droplet amount of ink.

In a preferred embodiment, the printhead comprises a nozzle array on which nozzles for discharging a third droplet amount of ink are arrayed, and the first storage means stores printing data for discharging the first droplet amount of ink and printing data for discharging the third droplet amount of ink.

In still another aspect of the present invention, the foregoing object is attained by providing a printing apparatus which performs printing by using a printhead having a nozzle array on which nozzles for discharging dark ink are arrayed, and a nozzle array on which nozzles for discharging light ink are arrayed, comprising: input means for inputting printing data containing a flag representing a type of printing mode from an external device; scanning means for scanning the printhead in a direction different from a nozzle array direction; a plurality of storage means for temporarily holding the printing data input by the input means; control means for selecting storage means serving as a holding destination for the printing data from the plurality of storage means on the basis of the flag in the printing data that represents the type of printing mode, and storing the printing data in the selected storage means; and transfer means for transferring the printing data stored in the storage means to the printhead.

In still another aspect of the present invention, the foregoing object is attained by providing a printing apparatus which performs printing by using a printhead having a nozzle array on which nozzles with a first orifice diameter are arrayed, and a nozzle array on which nozzles with a second orifice diameter are arrayed, comprising: input means for inputting printing data containing a flag representing a type of printing mode from an external device; scanning means for scanning the printhead in a direction different from a nozzle array direction; a plurality of storage means for temporarily holding the printing data input by the input means; control means for selecting storage means serving as a holding destination for the printing data from the plurality of storage means on the basis of the flag in the printing data that represents the type of printing mode, and storing the printing data in the selected storage means; and transfer means for transferring the printing data stored in the storage means to the printhead.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a perspective view showing the outer appearance of an ink-jet printer according to the first embodiment of the present invention;

FIG. 2 is a view showing the arrangement of a printhead according to the first embodiment of the present invention;

FIG. 3 is a block diagram showing a control circuit which is mounted in the ink-jet printer according to the first embodiment of the present invention;

FIG. 4 is a flow chart showing processing executed by a host computer and control circuit according to the first embodiment of the present invention;

FIG. 5 is a block diagram showing a control circuit which is mounted in the ink-jet printer according to the third embodiment of the present invention;

FIG. 6 is a flow chart showing processing executed by a host computer and control circuit according to the third embodiment of the present invention; and

FIG. 7 is a view showing the arrangement of a conventional printhead.

### DETAILED DESCRIPTION OF THE PREFERRED EMBODIMENTS

Preferred embodiments of the present invention will be described in detail below with reference to the accompanying drawings.

First Embodiment

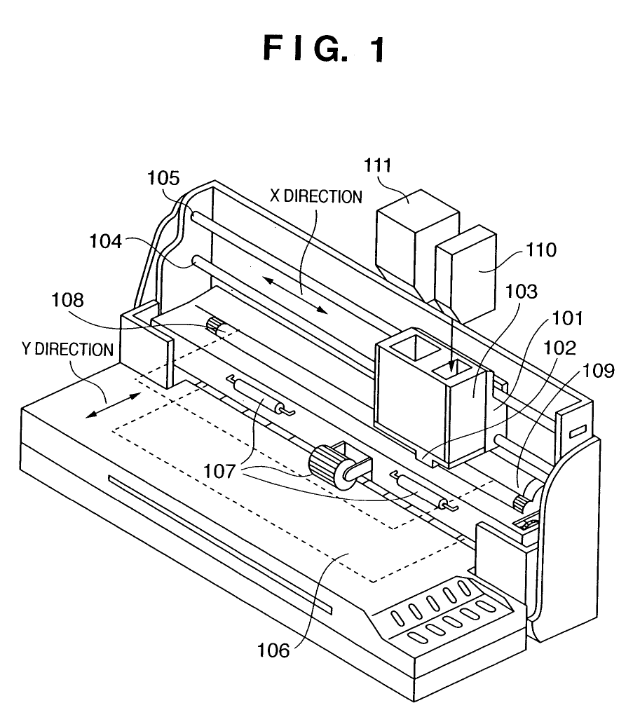

FIG. 1 is a perspective view showing the outer appearance of an ink-jet printer according to the first embodiment of the present invention.

The ink-jet printer has an arrangement capable of both color printing and monochrome printing. When the printer is a monochrome printing-dedicated apparatus, only an ink cartridge (to be described later) which stores black ink is mounted on the printhead.

As shown in FIG. 1, a printhead 102 and cartridge guide 103 are mounted on a carriage 101. The printhead 102 is a multi-nozzle printhead having 128 large nozzles for black, and 128 nozzles for each of large and small nozzle (printing element) diameters for each color. The printhead 102 discharges black (K) ink, or cyan (C), magenta (M), yellow (Y), and black (K) inks.

In printer operation, an ink cartridge 110 which stores black ink and an ink cartridge 111 which stores the remaining three color inks are mounted in the printhead 102. The ink cartridges supply cyan (C), magenta (M), yellow (Y), and black (K) inks. A driving signal for each nozzle of the printhead 102 is supplied via a flexible cable (not shown) prepared by laying out many conductors.

The carriage 101 is mounted on two guide rails 104 and 105. An endless belt coupled to the carriage 101 is driven by a carrier motor (not shown) to reciprocally travel the carriage 101 in the X direction (to be referred to as a main scanning direction hereinafter). An auxiliary roller 107 which is driven by a convey motor (not shown) conveys a printing sheet 106 to a position printable by the printhead 102. Convey rollers 108 and 109 which are driven by the convey motor (not shown) convey the printing sheet 106 in the Y direction (to be referred to as a sub-scanning direction hereinafter) every time one line is printed by reciprocal scanning of the carriage 101.

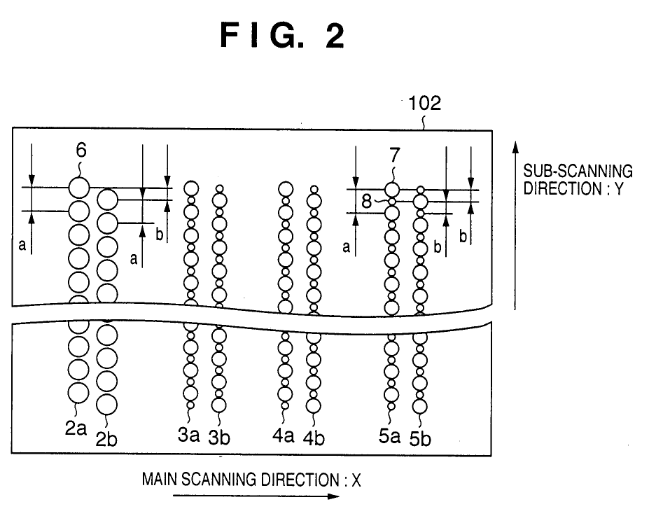

The arrangement of the printhead 102 according to the first embodiment will be explained with reference to FIG. 2.

FIG. 2 is a view showing the arrangement of the printhead according to the first embodiment of the present invention.

In FIG. 2, reference numeral 2a denotes an array of first, third, fifth, . . . , 125th, and 127th odd-numbered nozzles which discharge black ink; and 2b, an array of second, fourth, sixth, . . . , 126th, and 128th even-numbered nozzles which discharge black ink. A blank ink orifice 6 has a size for discharging 30 pl of ink per droplet. A distance a between adjacent ink orifices on the same nozzle array is 1/300 inches. A distance b between adjacent ink orifices on different nozzle arrays is 1/600 inches.

Similarly, reference numerals 3a and 3b denote cyan nozzle arrays; 4a and 4b, magenta nozzle arrays; and 5a and 5b, yellow nozzle arrays. Each color nozzle array comprises an ink orifice 7 which discharges 5 pl of ink per droplet, and an ink orifice 8 which discharges 2 pl of ink per droplet. The distance a between adjacent ink orifices equal in size on the same nozzle array is 1/300 inches, similar to the black nozzle array. The distance b between adjacent ink orifices different in size on the same nozzle array is 1/600 inches.

Note that the ink orifices 6 to 8 have different orifice diameters each other.

In the use of the printhead 102, a maximum number of four color nozzles can discharge ink to a 1/600″ square as far as a total discharge amount of 5 pl of ink and 2 pl of ink does not exceed 20 pl at maximum. Table 1 shows combinations:

TABLE 1

| Total Ink Droplet | 5-p1 Ink | 2-p1 Ink |
|---|---|---|
| Amount [p1] | [Count] | [Count] |
| 0 | 0 | 0 |
| 2 | 0 | 1 |
| 4 | 0 | 2 |
| 5 | 1 | 0 |
| 6 | 0 | 3 |
| 7 | 1 | 1 |
| 8 | 0 | 4 |
| 9 | 1 | 2 |
| 10 | 2 | 0 |
| 11 | 1 | 3 |
| 12 | 2 | 1 |
| 13 | 1 | 4 |
| 14 | 2 | 2 |
| 15 | 3 | 0 |
| 16 | 2 | 3 |
| 17 | 3 | 1 |
| 18 | 2 | 4 |
| 19 | 3 | 2 |
| 20 | 4 | 0 |

Nine tone levels can be printed.

A print buffer capacity necessary to form an image for main scanning operations by the printhead 102 at an 8″ width by using the above-described conventional printer arrangement is

| | | | Number of | Number of | Number | Memory capa- |
|---|---|---|---|---|---|---|
| | dpi | Inch | nozzles | arrays | of dots | city [bits] |
| Black | 600 × | 8 × | 64 × | 2 × | 2 = | 1,228,800 (6) |
| head: | | | | | | |
| (30 pl) | | | | | | |
| Yellow | 600 × | 8 × | 64 × | 2 × | 4 = | 2,457,600 (7) |
| head: | | | | | | |
| (5 pl) | | | | | | |
| Yellow | 600 × | 8 × | 64 × | 2 × | 4 = | 2,457,600 (8) |
| head: | | | | | | |
| (2 pl) | | | | | | |
| Cyan | 600 × | 8 × | 64 × | 2 × | 4 = | 2,457,600 (9) |
| head: | | | | | | |
| (5 pl) | | | | | | |
| Cyan | 600 × | 8 × | 64 × | 2 × | 4 = | 2,457,600 (10) |
| head: | | | | | | |
| (2 pl) | | | | | | |
| Ma- | 600 × | 8 × | 64 × | 2 × | 4 = | 2,457,600 (11) |
| genta | | | | | | |
| head: | | | | | | |
| (5 pl) | | | | | | |
| Ma- | 600 × | 8 × | 64 × | 2 × | 4 = | 2,457,600 (12) |
| genta | | | | Total | = | 15,974,400 |
| head: | | | | | | (13) |
| (2 pl) | | | | | | |

A capacity used to map data of the next scanning in the print buffer during one main scanning is multiplied by 1.25 times, requiring a memory capacity of

15,974,400×1.25=19,968,000 bits (14)

In general, the print buffer has such large capacity, and a DRAM is used as a storage means and selected from 4-Mbit, 16-Mbit, and 64-Mbit DRAMs. A conventional system can be constituted by a 16-Mbit DRAM, whereas the system must be constituted by a 64-Mbit DRAM in the use of a printhead capable of finer tonal expression. As a result, the cost of the storage means increases four times or more.

Similar to the use of a conventional printhead, one main scanning ends within about 0.5 sec. In order to transfer data (3,993,600 bits) which is ¼ of a total of 15,974,400 bits during one main scanning, a necessary interface transfer rate for one main scanning time of 0.5 sec is

15,974,400÷4÷0.5=7,987,200 bits/sec (998.4 kbytes/sec) (15)

This transfer rate is much higher than the transfer rate of the IEEE 1284 ECP mode, and can only be achieved by the transfer rate of a USB interface.

As a method of suppressing the print buffer capacity, Japanese Patent Laid-Open No. 11-227259 discloses the following method. According to this method, data necessary for one main scanning is transferred every main scanning. In this case, the print buffer capacity is

| | | | Number of | Number of | Number | Memory capa- |
|---|---|---|---|---|---|---|
| | dpi | Inch | nozzles | arrays | of dots | city [bits] |
| Black | 600 × | 8 × | 64 × | 2 × | 1 = | 614,400 (16) |
| head: | | | | | | |
| (30 pl) | | | | | | |
| Yellow | 600 × | 8 × | 64 × | 2 × | 1 = | 614,400 (17) |
| head: | | | | | | |
| (5 pl) | | | | | | |
| Yellow | 600 × | 8 × | 64 × | 2 × | 1 = | 614,400 (18) |
| head: | | | | | | |
| (2 pl) | | | | | | |
| Cyan | 600 × | 8 × | 64 × | 2 × | 1 = | 614,400 (19) |
| head: | | | | | | |
| (5 pl) | | | | | | |
| Cyan | 600 × | 8 × | 64 × | 2 × | 1 = | 614,400 (20) |
| head: | | | | | | |
| (2 pl) | | | | | | |
| Ma- | 600 × | 8 × | 64 × | 2 × | 1 = | 614,400 (21) |
| genta | | | | | | |
| head: | | | | | | |
| (5 pl) | | | | | | |
| Ma- | 600 × | 8 × | 64 × | 2 × | 1 = | 614,400 (22) |
| genta | | | | Total | = | 4,300,800 (23) |
| head: | | | | | | |
| (2 pl) | | | | | | |

In this case, all data of the next scanning must be mapped in the print buffer during one main scanning, and the memory capacity must be doubled:

4,300,800×2=8,601,600 bits (24)

However, this capacity is smaller than the conventional one.

Transfer of data of a total of 4,300,800 bits during one main scanning requires a higher-speed interface. Since one main scanning ends within about 0.5 sec, a necessary interface transfer rate for one main scanning time of 0.5 sec is

4,300,800÷0.5÷=8,601,600 bits/sec (1075.2 kbytes/sec) (25)

This transfer rate is much higher than the transfer rate of the IEEE 1284 ECP mode.

If the printhead 102 is used, one 30-pl black ink droplet, or one 5-pl color ink droplet and one 2-pl color ink droplet can be discharged in 1/600 inches in the sub-scanning direction by one main scanning. The landing position must be controlled separately for discharge of 5-pl color ink and discharge of 2-pl color ink. The present invention, therefore, employs a printing method in which 5-pl ink and 2-pl ink are discharged separately in different main scanning operations.

In this case, equations (6) to (25) for the print buffer capacity and interface transfer rate must be rewritten.

As for the print buffer capacity in equations (6) to (14), data of 2-pl color ink suffices to be stored during printing with 30-pl black ink and 5-pl color ink. A necessary print buffer need not be multiplied by 1.25, and a necessary print buffer capacity is

15,974,400×1=15,974,400 bits (26)

This capacity is still large for the print buffer, and the system cannot be constituted using a 16-Mbit DRAM.

The system in which the print buffer capacity is reduced in equations (16) to (25) must transfer, within 0.5 sec, data:

| | | | Number of | Number of | Number | Memory capa- |
|---|---|---|---|---|---|---|
| | dpi | Inch | nozzles | arrays | of dots | city [bits] |
| Black | 600 × | 8 × | 64 × | 2 × | 1 = | 614,400 (27) |
| head: | | | | | | |
| (30 pl) | | | | | | |
| Yellow | 600 × | 8 × | 64 × | 2 × | 1 = | 614,400 (28) |
| head: | | | | | | |
| (5 pl) | | | | | | |
| Cyan | 600 × | 8 × | 64 × | 2 × | 1 = | 614,400 (29) |
| head: | | | | | | |
| (5 pl) | | | | | | |
| Ma- | 600 × | 8 × | 64 × | 2 × | 1 = | 614,400 (30) |
| genta | | | | Total | = | 2,457,600 (31) |
| head: | | | | | | |
| (5 pl) | | | | | | |

A necessary interface transfer rate is

2,457,600÷0.5=4,915,200 bits/sec (32)

Even this transfer rate is higher than the transfer rate of the IEEE 1284 ECP mode, and can only be achieved by the transfer rate of a USB interface.

From this, the present invention proposes a printing apparatus which suppresses an increase in cost by suppressing an increase in print buffer that poses a problem in the use of a printhead capable of finer tonal expression, and suppresses an increase in transfer data rate to the transfer rate of an existing interface.

By using the printhead 102 in FIG. 2, one 30-pl black ink droplet, or one 5-pl color ink droplet and one 2-pl color ink droplet can be discharged in 1/600 inches in the sub-scanning direction by one main scanning. The landing position must be controlled separately for discharge of 5-pl color ink and discharge of 2-pl color ink. The present invention will explain a printing method in which 5-pl ink and 2-pl ink are discharged separately in different main scanning operations.

The ink-jet printer according to the present invention can realize multipass printing in which printing in the same printing region is completed by a plurality of printing scanning operations.

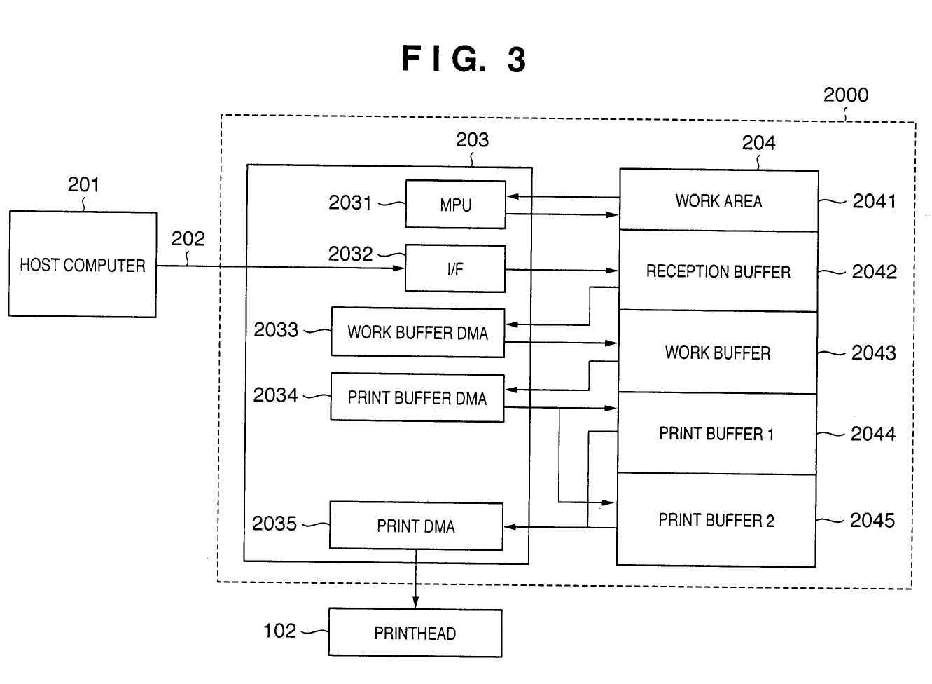

FIG. 3 is a block diagram showing a control circuit which is mounted in the ink-jet printer according to the first embodiment of the present invention.

Reference numeral 201 denotes a host computer which transmits printing data to a control circuit 2000 of the ink-jet printer. The host computer 201 generates printing data for realizing printing control in the control circuit 2000 (to be described later), and controls output of the control data to the control circuit 2000. Generation and output control of printing data are realized by, e.g., a dedicated program such as a printer driver installed in the host computer 201, but may be realized by dedicated hardware which realizes processing executed by the dedicated program.

The host computer 201 has various building components such as a keyboard, mouse, display, CPU, RAM, and ROM (none of them are shown) which constitute a general-purpose computer such as a personal computer or work station.

Printing data output from the host computer 201 to the control circuit 2000 includes the first image data for single pass (first printing mode) in which printing in a predetermined printing region is completed by one printing scanning of the printhead 102, and the second image data for each pass out of printing data for multipass (second printing mode) in which printing in a predetermined printing region is completed by a plurality of printing scanning operations of the printhead 102. The host computer 201 generates various pieces of printing control information containing image data flags (first and second image data flags) representing the types of first and second image data. The host computer 201 transmits, as printing data to the control circuit 2000, printing control information containing the first or second image data and a corresponding image data flag.

Reference numeral 2032 denotes an interface (I/F) such as an IEEE 1284 or USB 1.1 interface which receives printing data via an interface line 202 between the host computer 201 and the control circuit 2000. In the use of the IEEE 1284 ECP mode, the maximum effective data transfer rate is about 500 kbytes/sec. In the use of the high-speed mode of a USB 1.1 interface, the maximum effective data transfer rate is about 800 kbytes/sec.

Reference numeral 203 denotes a printing data processor which processes printing data received from the host computer 201 into data printable by the printhead 102. Printing data is temporarily stored in an external storage unit 204 (in the first embodiment, a 16-Mbit DRAM) during data processing.

In the printing data processor 203, reference numeral 2031 denotes a microprocessor (MPU) which controls each block for performing data processing. The MPU 2031 analyzes the contents of printing data which is received from the interface 2032 and contains the first or second image data and a corresponding image data flag. The MPU 2031 properly controls the following processing on the basis of the analysis result.

A 1-Mbit work area 2041 for operating the MPU 2031 is ensured in the 16-Mbit external storage unit 204. Also, a 0.5-Mbit reception buffer 2042 for receiving printing data from the interface 2032 is ensured. A 2-Mbit work buffer 2043 for converting printing data into printhead printing data in a format printable by the printhead 102 is ensured. The remaining 12.5-Mbit memory area is ensured as print buffer 1 (2044) and print buffer 2 (2045) which store printhead printing data.

In order to generate printhead printing data, the MPU 2031 extracts only image data from printing data stored in the reception buffer 2042, and temporarily maps the image data in the work buffer 2043. A work buffer DMA unit 2033 receives an instruction from the MPU 2031, and accesses the external storage unit 204.

A print buffer DMA unit 2034 performs operation of writing data in a print buffer memory area designated by the MPU 2031 while converting image data stored in the work buffer 2043 into printhead printing data corresponding to the layout direction of the printhead 102.

Print buffer 1 (2044) is a print buffer which is an area for storing only image data (single-pass first image data) necessary for printing in a predetermined region by one main scanning and is rewritten in the entire area every main scanning. Print buffer 2 (2045) is a print buffer which is an area for storing all image data (multipass second image data) for completing printing in a predetermined region by a plurality of (e.g., four in the first embodiment) main scanning operations and is rewritten every main scanning in only an area where an image is completed.

Reference numeral 2035 denotes a print DMA unit which transfers image data stored in the print buffer to the printhead 102.

In the first embodiment, as for printing data of 30-pl black ink and printing data of 5-pl color ink, the host computer 201 transfers, to the control circuit 2000, printing data containing the first image data for one main scanning in a predetermined printing region and the first image data flag representing the first image data. The control circuit 2000 stores the printhead printing data of the first image data out of the printing data in print buffer 1 (2044).

As for printing data of 2-pl color ink, the host computer 201 transfers, to the control circuit 2000, printing data containing the second image data for a plurality of main scanning operations in a predetermined printing region and the second image data flag representing the second image data. The control circuit 2000 stores the printhead printing data of the second image data out of the printing data in print buffer 2 (2045). At this time, the control circuit 2000 stores data of 2-pl color ink in print buffer 2 (2045) during printing of 30-pl black ink and 5-pl color ink. During printing of 2-pl color ink, data of 30-pl black ink and 5-pl color ink are stored in print buffer 2 (2045).

For example, in printing of 30-pl black ink and 5-pl color ink, printing data of 30-pl black ink and printing data of 5-pl color ink are transferred four times from the host computer 201 in order to perform four scanning printing operations in a predetermined region.

In printing of 2-pl color ink, printing data of 2-pl color ink is transferred once from the host computer 201 in order to perform four scanning printing operations in a predetermined region.

By using equations (27) to (30), the necessary capacity of print buffer 1 (2044) is

| | | | Number of | Number of | Number | Memory capa- |
|---|---|---|---|---|---|---|
| | dpi | Inch | nozzles | arrays | of dots | city [bits] |
| Black | 600 × | 8 × | 64 × | 2 × | 1 = | 614,400 (33) |
| head: | | | | | | |
| (30 pl) | | | | | | |
| Yellow | 600 × | 8 × | 64 × | 2 × | 1 = | 614,400 (34) |
| head: | | | | | | |
| (5 pl) | | | | | | |
| Cyan | 600 × | 8 × | 64 × | 2 × | 1 = | 614,400 (35) |
| head: | | | | | | |
| (5 pl) | | | | | | |
| Ma- | 600 × | 8 × | 64 × | 2 × | 1 = | 614,400 (36) |
| genta | | | | Total | = | 2,457,600 (37) |
| head: | | | | | | |
| (5 pl) | | | | | | |

The necessary capacity of print buffer 2 (2045) is

| | | | Number of | Number of | Number | Memory capa- |
|---|---|---|---|---|---|---|
| | dpi | Inch | nozzles | arrays | of dots | city [bits] |
| Yellow | 600 × | 8 × | 64 × | 2 × | 4 = | 2,457,600 (38) |
| head: | | | | | | |
| (2 pl) | | | | | | |
| Cyan | 600 × | 8 × | 64 × | 2 × | 4 = | 2,457,600 (39) |
| head: | | | | | | |
| (2 pl) | | | | | | |
| Ma- | 600 × | 8 × | 64 × | 2 × | 4 = | 2,457,600 (40) |
| genta | | | | Total | = | 7,372,800 |
| head: | | | | | | |
| (2 pl) | | | | | | |

Accordingly, a print buffer having a total capacity of

2,457,600+7,372,800=9,830,400 bits (42)

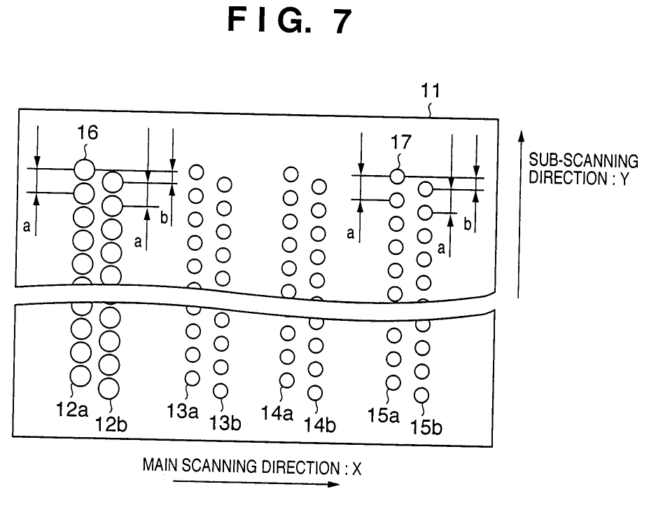

suffices to be prepared, and the capacity falls within 12 Mbits. The print buffer capacity can be reduced by 921,600 bits from a print buffer capacity of 10,752,000 bits necessary for the conventional printhead shown in FIG. 7. The system can be constructed by a 16-Mbit DRAM.

Since all data (2,457,600 bits) stored in print buffer 1 are used for printing by one main scanning, 2,457,600 bits are transferred every main scanning. Since ¼ of data (7,372,800 bits) stored in print buffer 2 are used for printing by one main scanning, data (1,843,200 bits) which are ¼ of 7,372,800 bits suffice to be transferred.

Hence, only data of 2,457,600 bits or data (1,843,200 bits) which is ¼ of 7,372,800 bits suffice to be transferred during one main scanning. One main scanning ends within 0.5 sec, and thus necessary interface transfer rates are

2,457,600/0.5=4,915,200 bits/sec (43)

1,843,200/0.5=3,686,400 bits/sec (44)

A necessary interface rate is a rate having the larger value:

4,915,200 bits/sec (614.4 kbytes/sec) (45)

This interface rate can be realized by the transfer rate of a USB interface.

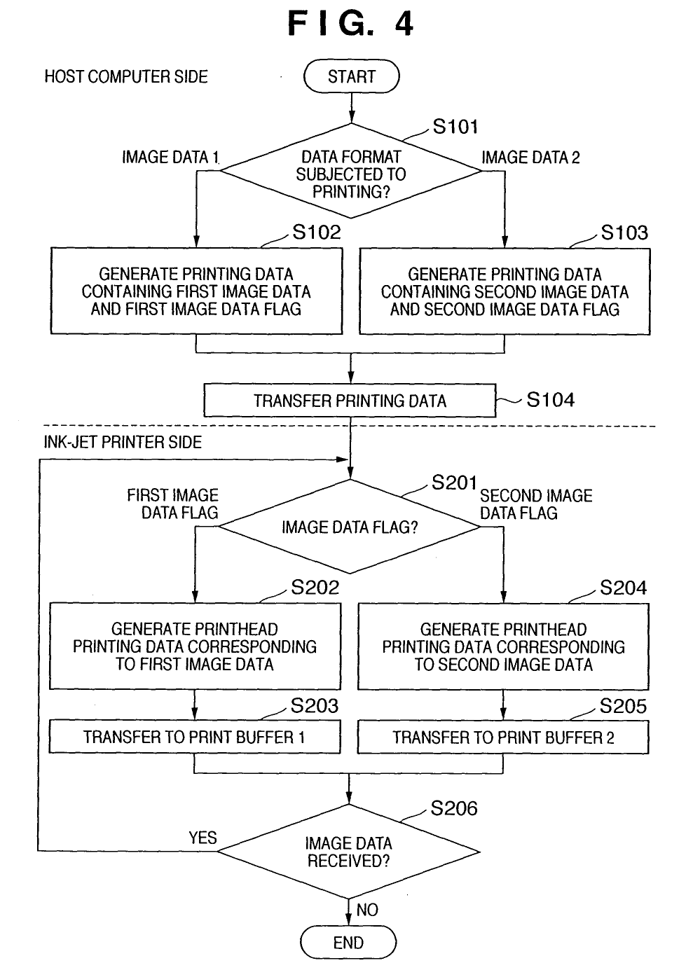

The processing flow of processing executed by the host computer 201 and control circuit 2000 according to the first embodiment will be explained with reference to FIG. 4.

FIG. 4 is a flow chart showing processing executed by the host computer and control circuit according to the first embodiment of the present invention.

In step S101, the host computer 201 determines the data format of data to be printed by the ink-jet printer. If printing of 30-pl black ink and printing of 5-pl color ink are to be performed, data is determined to be the first image data; if printing of 2-pl color ink is to be performed, data is determined to be the second image data.

If the data format is the first image data in step S101, the host computer 201 generates printing data containing the first image data and first image data flag in step S102. In step S104, the host computer 201 transfers the generated printing data to the ink-jet printer.

If the data format is the second image data in step S101, the host computer 201 generates printing data containing the second image data and second image data flag in step S103. In step S104, the host computer 201 transfers the generated printing data to the ink-jet printer.

In the ink-jet printer, for example, in step S201 of receiving printing data in a standby state, the MPU 2031 of the control circuit 2000 determines the type of image data flag in the printing data stored in the reception buffer 2042.

If the type of image data flag is the first image data flag, the MPU 2031 generates printhead printing data corresponding to the first image data by using the work buffer 2043 and work buffer DMA unit 2033 in step S202. In step S203, the MPU 2031 transfers the generated printhead printing data to print buffer 1 (2044).

If the type of image data flag is the second image data flag, the MPU 2031 generates printhead printing data corresponding to the second image data by using the work buffer 2043 and work buffer DMA unit 2033 in step S204. In step S205, the MPU 2031 transfers the generated printhead printing data to print buffer 2 (2045).

In step S206, whether image data has been received from the host computer 201 is determined. If image data has been received (YES in step S206), the flow returns to step S201 to continue processing. If no image data has been received (NO in step S206), the processing ends.

If a sufficient amount of image data is stored in print buffer 1 (2044) and print buffer 2 (2045), image data can be transferred to the printhead 102 to perform printing operation.

As described above, according to the first embodiment, the contents of printing data to be printed on a printing medium by the printhead 102 can be transferred from the host computer 201 by using an existing interface (USB interface) without increasing the capacity of the storage unit of the printing apparatus. The printhead 102 can print pixels having different dot diameters, improving the tonality of a printed image.

Second Embodiment

The first embodiment achieves 19-level tonal expression, as shown in Table 1, by discharging a maximum number of four ink droplets from each of 5-pl, yellow, cyan, and magenta nozzles and a maximum number of four ink droplets from each 2-pl nozzle. To the contrary, as shown in Table 2, the second embodiment can realize 15-level tonal expression by discharging a maximum number of two ink droplets from each 5-pl nozzle and a maximum number of four ink droplets from each 2-pl nozzle.

TABLE 2

| Total Ink Droplet | 5-p1 Ink | 2-p1 Ink |
|---|---|---|
| Amount [p1] | [Count] | [Count] |
| 0 | 0 | 0 |
| 2 | 0 | 1 |
| 4 | 0 | 2 |
| 5 | 1 | 0 |
| 6 | 0 | 3 |
| 7 | 1 | 1 |
| 8 | 0 | 4 |
| 9 | 1 | 2 |
| 10 | 2 | 0 |
| 11 | 1 | 3 |
| 12 | 2 | 1 |
| 13 | 1 | 4 |
| 14 | 2 | 2 |
| 16 | 2 | 3 |
| 18 | 2 | 4 |

In this case, the maximum ink discharge amount decreases from 20 pl to 18 pl, and the maximum density slightly decreases, which hardly influences an image. The data transfer amount from a host computer 201 to a control circuit 2000 can be reduced, and a necessary transfer rate can be satisfied by the transfer rate of the IEEE 1284 ECP mode.

Data corresponding to 5-pl yellow, cyan, and magenta ink orifices 7 can be greatly reduced.

In the second embodiment, the host computer 201 sets printing data of 30-pl black ink and printing data of 5-pl color ink as the second image data for printing in a predetermined printing region by a plurality of main scanning operations. The host computer 201 transfers printing data containing the second image data to the control circuit 2000. The control circuit 2000 stores printhead printing data of the second image data out of the printing data in print buffer 2 (2044).

The host computer 201 sets printing data of 2-pl color ink as the first image data for printing in a predetermined printing region by a plurality of main scanning operations. The host computer 201 transfers printing data containing the first image data to the control circuit 2000. The control circuit 2000 stores printhead printing data of the first image data out of the printing data in print buffer 1 (2045).

The necessary capacity of print buffer 2 (2045) is

| | | | Number of | Number of | Number | Memory capa- |
|---|---|---|---|---|---|---|
| | dpi | Inch | nozzles | arrays | of dots | city [bits] |
| Black | 600 × | 8 × | 64 × | 2 × | 2 = | 1,228,800 (46) |
| head: | | | | | | |
| (30 pl) | | | | | | |
| Yellow | 600 × | 8 × | 64 × | 2 × | 2 = | 1,228,800 (47) |
| head: | | | | | | |
| (5 pl) | | | | | | |
| Cyan | 600 × | 8 × | 64 × | 2 × | 2 = | 1,228,800 (48) |
| head: | | | | | | |
| (5 pl) | | | | | | |
| Ma- | 600 × | 8 × | 64 × | 2 × | 2 = | 1,228,800 (49) |
| genta | | | | Total | = | 4,915,200 (50) |
| head: | | | | | | |
| (5 pl) | | | | | | |

The necessary capacity of print buffer 1 (2044) is

| | | | Number of | Number of | Number | Memory capa- |
|---|---|---|---|---|---|---|
| | dpi | Inch | nozzles | arrays | of dots | city [bits] |
| Yellow | 600 × | 8 × | 64 × | 2 × | 1 = | 614,400 (51) |
| head: | | | | | | |
| (2 pl) | | | | | | |
| Cyan | 600 × | 8 × | 64 × | 2 × | 1 = | 614,400 (52) |
| head: | | | | | | |
| (2 pl) | | | | | | |
| Ma- | 600 × | 8 × | 64 × | 2 × | 1 = | 614,400 (53) |
| genta | | | | Total | = | 1,843,200 (54) |
| head: | | | | | | |
| (2 pl) | | | | | | |

In this case, the next scanning may target printing of 2-pl color ink again, and data of the next main scanning must be mapped in print buffer 1 (2044) during one main scanning. A necessary memory capacity is as double as

1,843,200×2=3,686,400 bits (55)

Hence, a print buffer having a total capacity of

4,915,200+3,686,400=8,601,600 bits (56)

suffices to be prepared, and the capacity necessary for the print buffer can be further reduced.

Only data (1,228,800 bits) which is ¼ of 4,915,200 bits, or data of 1,843,200 bits suffices to be transferred during one main scanning. Since one main scanning ends within 0.5 sec, necessary interface transfer rates are

1,228,800/0.5=2,457,600 bits/sec (57)

1,843,200/0.5=3,686,400 bits/sec (58)

A necessary interface rate is a rate having the larger value:

3,686,400 bits/sec (460.8 kbytes/sec) (59)

This interface rate can be achieved by the transfer rate of the IEEE 1284 ECP mode or the transfer rate of a USB interface.

The processing flow of processing executed by the host computer 201 and control circuit 2000 according to the second embodiment is the same as that in the first embodiment except determination in step S101 in the flow chart of FIG. 4.

That is, in the second embodiment, if printing of 30-pl black ink and printing of 5-pl color ink are to be performed, data is determined in step S101 to be the second image data; if printing of 2-pl color ink is to be performed, data is determined to be the first image data.

As described above, according to the second embodiment, in addition to the effects of the first embodiment, printing data can be transferred from the host computer 201 by using an interface (IEEE 1284 ECP mode) having a lower transfer rate among existing interfaces. A printhead 102 can print pixels at different dot diameters, improving the tonality of a printed image.

Third Embodiment

In the first and second embodiments, printhead printing data are mapped in print buffer 1 and print buffer 2 from the work buffer 2043 via the print buffer DMA unit 2034 which performs data processing for original printing data

In practice, printhead printing data corresponding to the first image data to be written in print buffer 1 (2044) suffices to be directly written in print buffer 1 (2044) by extracting only image data 1 from printing data transferred by a host computer 201. A print buffer DMA unit 2034 merely transfers data between a work buffer 2043 and print buffer 1 (2044) without any data processing.

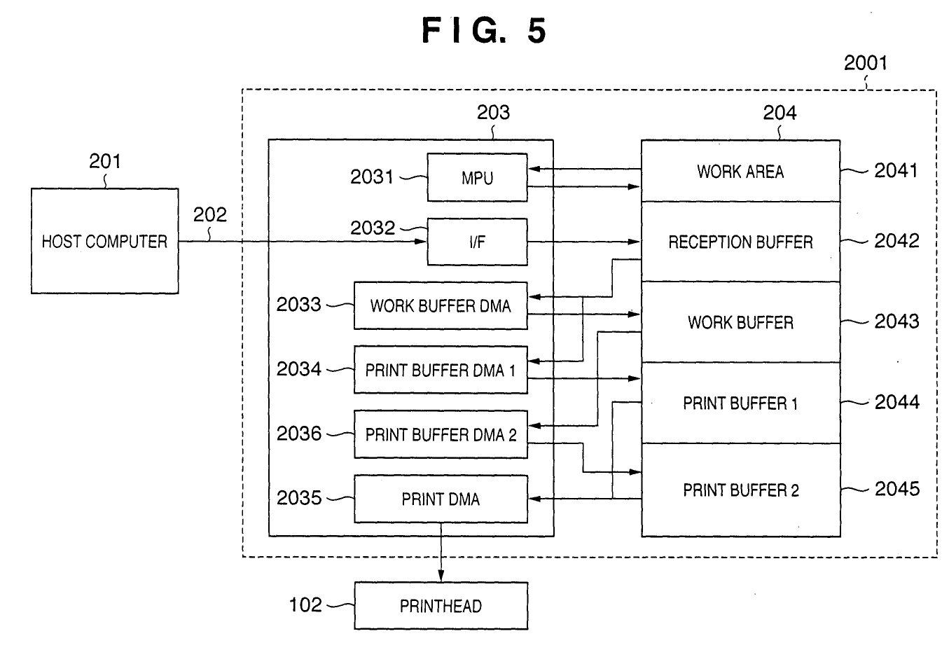

The third embodiment increases the data processing efficiency by adding a print buffer DMA 2 unit 2036 to the control circuit 2000 in FIG. 3 to constitute a control circuit 2001 in FIG. 5.

In FIG. 5, the same reference numerals as in FIG. 3 denote the same parts.

Upon reception of printing data containing the first image data from the host computer 201, the control circuit 2001 extracts only the first image data from the printing data stored in a reception buffer 2042, and transfers the first image data to print buffer 1 (2044) by using the print buffer DMA 1 unit 2034.

Upon reception of printing data containing the second image data from the host computer 201, the control circuit 2001 transfers printhead printing data of the second image data to print buffer 2 (2045) by using the print buffer DMA 2 unit (2036), similar to the first and second embodiments.

An MPU 2031 selects the print buffer DMA 1 unit 2034 or print buffer DMA 2 unit 2036 on the basis of the image data flag in printing data stored in the reception buffer 2042.

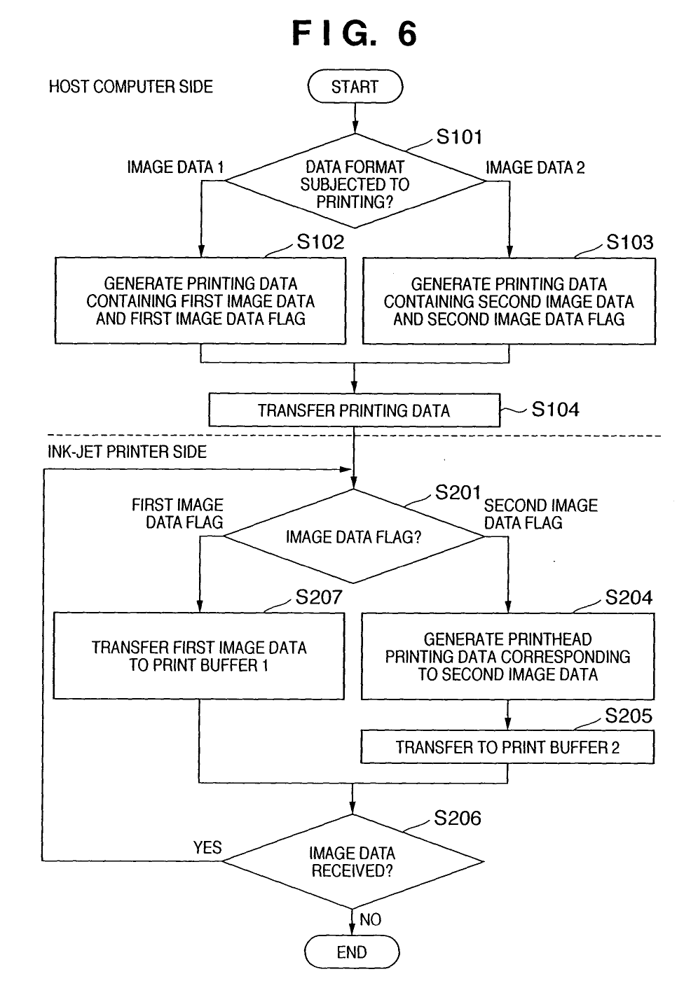

The processing flow of processing executed by the host computer 201 and control circuit 2001 according to the third embodiment is the same as that in the first embodiment except that, as shown in FIG. 6, step S207 replaces processes in steps S202 and S203 in the flow chart of FIG. 4.

That is, in the third embodiment, the first image data in printing data stored in the reception buffer 2042 is transferred to print buffer 1 (2044) in step S207. In step S206, printhead printing data stored in print buffer 1 is transferred to the printhead 102 to execute printing operation.

As described above, in addition to the effects of the first and second embodiments, the third embodiment can decrease the access frequency to the data processing work buffer 2043 by employing the print buffer DMA 2 unit (2036). As a result, the load on data processing of the whole system can be reduced.

The present invention has described, of ink-jet printing systems, a printing apparatus which comprises a means (e.g., an electrothermal transducer or laser beam) for generating heat energy as energy utilized to discharge ink and changes the ink state by heat energy. This system can achieve high printing density and high resolution.

In the above embodiments, single-pass (first printing mode) image data is the first image data. Printing data for each pass out of printing data for multipass (second printing mode) in which the printhead 102 completes printing in a predetermined printing region by a plurality of printing scanning operations is the second image data. However, the present invention is not limited to this.

For example, the present invention can also be applied to printing using dark and light inks of color inks (cyan, magenta, and yellow). In this case, the present invention is applied using data of dark yellow ink, dark magenta ink, and dark cyan ink as the first image data, and data of light yellow ink, light magenta ink, and light cyan ink as the second image data.

As a representative arrangement or principle, the present invention preferably adopts the basic principle disclosed in, e.g., U.S. Pat. Nos. 4,723,129 or 4,740,796. This system is applicable to both a so-called on-demand apparatus and continuous apparatus. The system is particularly effective for the on-demand apparatus because of the following reason. At least one driving signal which corresponds to printing information and gives a rapid temperature rise exceeding nuclear boiling is applied to an electrothermal transducer which is arranged in correspondence with a sheet or liquid channel holding a liquid (ink). This signal causes the electrothermal transducer to generate heat energy, and causes film boiling on the heat effecting surface of the printhead. Consequently, a bubble can be formed in the liquid (ink) in one-to-one correspondence with the driving signal. Growth and shrinkage of the bubble discharge the liquid (ink) from an orifice, forming at least one droplet. The driving signal more preferably has a pulse shape because a bubble grows and shrinks instantaneously appropriately to achieve discharge of the liquid (ink) with high response.

The pulse-like driving signal is preferably a signal disclosed in U.S. Pat. No. 4,463,359 or 4,345,262. Conditions disclosed in U.S. Pat. No. 4,313,124 which is an invention concerning the temperature rise ratio of the heat effecting surface can provide higher-quality printing.

The printhead structure can be a combination (linear liquid channel or right-angle liquid channel) of orifices, liquid channels, and electrothermal transducers as disclosed in the above-mentioned specifications. The present invention also includes structures disclosed in U.S. Pat. Nos. 4,558,333 and 4,459,600 in which the heat effecting surface is arranged in a bent region.

It is also possible to employ an interchangeable chip type printhead which can be electrically connected to an apparatus main body and receive ink from the apparatus main body when attached to the apparatus main body, or a cartridge type printhead in which an ink tank is integrated with a printhead itself.

It is preferable to add a printhead recovery means or preliminary means to the printing apparatus of the present invention because the effects of the present invention can further stabilize. Practical examples of the additional means are a capping means for the printhead, a cleaning means, a pressurizing or suction means, an electrothermal transducer, another heating element, and a preliminary heating means as a combination of the electrothermal transducer and heating element. A predischarge mode in which discharge is performed independently of printing is also effective for stable printing.

The above-described embodiments of the present invention assume that ink is a liquid. It is also possible to use ink which solidifies at room temperature or less, or ink which softens or liquefies at room temperature. A general inkjet system performs temperature control such that the viscosity of ink falls within a stable discharge range by adjusting the ink temperature within the range of 30° C. (inclusive) to 70° C. (inclusive). Hence, ink need only be a liquid when a printing signal used is applied to it.

In order to prevent a temperature rise caused by heat energy by positively using the temperature rise as energy of the state change from the solid state to liquid state of ink, or to prevent evaporation of ink, ink which solidifies when left to stand and liquefies when heated can be used. In any case, the present invention is applicable to any ink which liquefies only when heat energy is applied, such as ink which liquefies when applied with heat energy corresponding to a printing signal and is discharged as liquid ink, or ink which already starts to solidify when arriving at a printing medium.

Furthermore, the printing apparatus according to the present invention can take any form: an integrated or separate image output terminal of an information processing apparatus such as a computer, a copying apparatus combined with a reader or the like, or a facsimile apparatus having a transmission/reception function.

The present invention is also achieved by supplying a software program (in the first and second embodiments, a program corresponding to the flow chart shown in FIG. 4, and in the third embodiment, a program corresponding to the flow chart shown in FIG. 6) for realizing the functions of the host computer 201, control circuit 2000, and control circuit 2001 in above-described embodiments to a system or apparatus directly or from a remote place, and reading out and executing the supplied program codes by the computer of the system or apparatus. In this case, the software need not be a program as far as it has a program function.

The present invention is therefore realized by program codes installed into the computer in order to realize functional processing of the present invention by the computer. That is, claims in the present invention include a computer program for realizing functional processing of the present invention.

In this case, the present invention can take any program form such as an object code, a program executed by an interpreter, or script data supplied to an OS as long as a program function is attained.

A recording medium for supplying the program includes a floppy® disk, hard disk, optical disk, magnetooptical disk, MO, CD-ROM, CD-R, CD-RW, magnetic tape, nonvolatile memory card, ROM, and DVD (DVD-ROM and DVD-R).

As another program supply method, the program can be supplied by connecting a client computer to an Internet homepage via the browser of the client computer, and downloading the computer program of the present invention or a compressed file containing an automatic installing function from the homepage to a recording medium such as a hard disk. The program can also be supplied by grouping program codes which constitute the program of the present invention into a plurality of files, and downloading the files from different homepages. That is, the present invention also includes a WWW server which allows a plurality of users to download the program files for realizing functional processing of the present invention by a computer.

The program of the present invention can be encrypted, stored in a storage medium such as a CD-ROM, and distributed to the user. A user who satisfies predetermined conditions is caused to download decryption key information from a homepage via the Internet. The user executes the encrypted program by using the key information, and installs the program in the computer.

The functions of the above-described embodiments are realized when the computer executes a readout program. Also, the functions of the above-described embodiments are realized when an OS or the like running on a computer performs part or all of actual processing on the basis of the instructions of the program.

The functions of the above-described embodiments are also realized when a program read out from a storage medium is written in the memory of a function expansion board inserted into a computer or the memory of a function expansion unit connected to the computer, and the CPU of the function expansion board or function expansion unit performs part or all of actual processing on the basis of the instructions of the program.

As many apparently widely different embodiments of the present invention can be made without departing from the spirit and scope thereof, it is to be understood that the invention is not limited to the specific embodiments thereof except as defined in the appended claims.

What is claimed is:

1. A printing apparatus which performs printing by using a printhead having a nozzle array on which nozzles for discharging a first droplet amount of ink are arrayed, and a nozzle array on which nozzles for discharging a second droplet amount of ink are arrayed, comprising:
input means for inputting printing data containing a flag representing a type of printing mode from an external device;
scanning means for scanning the printhead in a direction different from a nozzle array direction;
a plurality of storage means for temporarily holding the printing data input by said input means;
control means for selecting storage means serving as a holding destination for the printing data from said plurality of storage means on the basis of the flag in the printing data that represents the type of printing mode, and storing the printing data in said selected storage means; and
transfer means for transferring the printing data stored in said storage means to the printhead.

2. The apparatus according to claim 1, wherein
the type of printing mode includes at least a single-pass printing mode and a multipass printing mode,
flags representing the respective printing modes include first and second flags, and
said plurality of storage means include at least first storage means for storing first printing data for the single-pass printing mode and second storage means for storing second printing data for the multipass printing mode.

3. The apparatus according to claim 2, wherein
said plurality of storage means further comprise
a reception buffer which receives the printing data input by said input means, and
a work buffer for converting the printing data stored in the reception buffer into printhead printing data, and
the first and second printing data respectively correspond to the printhead printing data converted in the work buffer.

4. The apparatus according to claim 3, wherein when the flag in the printing data stored in the reception buffer is the first flag, said control means directly stores the printing data as the first printing data in said first storage means.

5. The apparatus according to claim 1, wherein the printhead includes an ink-jet printhead which discharges ink to perform printing.

6. The apparatus according to claim 1, wherein the printhead includes a printhead which discharges ink by using heat energy, and comprises a thermal transducer for generating heat energy to be applied to ink.

7. The apparatus according to claim 1, wherein the printhead includes a color printhead in which printing element groups each including a plurality of printing elements are arrayed by a number corresponding to the number of printing agents in a plurality of colors in the scanning direction of said scanning means in correspondence with the printing agents in the plurality of colors.

8. An information processing apparatus which generates printing data to be output to a printing apparatus, comprising:
generation means for generating printing data containing a flag representing a type of printing mode used for printing by the printing apparatus; and
output means for outputting the printing data generated by said generation means to the printing apparatus,
wherein the printing apparatus performs printing by using a printhead having a nozzle array on which nozzles for discharging a first droplet amount of ink are arrayed, and a nozzle array on which nozzles for discharging a second droplet amount of ink are arrayed.

9. A printing system constituted by connecting an information processing apparatus and a printing apparatus via a predetermined interface, wherein
the information processing apparatus comprises:
generation means for generating printing data containing a flag representing a type of printing mode used for printing by the printing apparatus;
output means for outputting the printing data generated by said generation means to the printing apparatus; and
input means for inputting the printing data containing the flag representing the type of printing mode from an external device, and
the printing apparatus comprises:
input means for inputting the printing data from the information processing apparatus;
printing means for performing printing by using a printhead having a nozzle array on which nozzles for discharging a first droplet amount of ink are arrayed, and a nozzle array on which nozzles for discharging a second droplet amount of ink are arrayed;
scanning means for scanning the printhead in a direction different from a convey direction;
a plurality of storage means for temporarily holding the printing data input by said input means;
control means for selecting storage means serving as a holding destination for the printing data from said plurality of storage means on the basis of the flag in the printing data that represents the type of printing mode, and storing the printing data in said selected storage means; and
transfer means for transferring the printing data stored in said storage means to the printhead.

10. A method of controlling a printing apparatus having a printhead with a nozzle array on which nozzles for discharging a first droplet amount of ink are arrayed, and a nozzle array on which nozzles for discharging a second droplet amount of ink are arrayed, comprising:
an input step of inputting printing data containing a flag representing a type of printing mode from an external device;
a scanning step of scanning the printhead in a direction different from a convey direction;
a control step of selecting a storage unit serving as a holding destination for the printing data from a plurality of storage units on the basis of the flag in the printing data that represents the type of printing mode, and storing the printing data in the selected storage unit; and
a transfer step of transferring the printing data stored in the storage unit to the printhead.

11. An information processing method of generating printing data to be output to a printing apparatus, comprising:
a generation step of generating printing data containing a flag representing a type of printing mode used for printing by the printing apparatus; and
an output step of outputting the printing data generated in the generation step to the printing apparatus,
wherein the printing apparatus performs printing by using a printhead having a nozzle array on which nozzles for discharging a first droplet amount of ink are arrayed, and a nozzle array on which nozzles for discharging a second droplet amount of ink are arrayed.

12. A program which causes a computer to control a printing apparatus having a printhead with a nozzle array on which nozzles for discharging a first droplet amount of ink are arrayed, and a nozzle array on which nozzles for discharging a second droplet amount of ink are arrayed, comprising:
a program code for an input step of inputting printing data containing a flag representing a type of printing mode from an external device;
a program code for a scanning step of scanning the printhead in a direction different from a convey direction;
a program code for a control step of selecting a storage unit serving as a holding destination for the printing data from a plurality of storage units on the basis of the flag in the printing data that represents the type of printing mode, and storing the printing data in the selected storage unit; and
a program code for a transfer step of transferring the printing data stored in the storage unit to the printhead.

13. A program which causes a computer to perform information processing for generating printing data to be output to a printing apparatus, comprising:
a program code for a generation step of generating printing data containing a flag representing a type of printing mode used for printing by the printing apparatus; and
a program code for an output step of outputting the printing data generated in the generation step to the printing apparatus,
wherein the printing apparatus performs printing by using a printhead having a nozzle array on which nozzles for discharging a first droplet amount of ink are arrayed, and a nozzle array on which nozzles for discharging a second droplet amount of ink are arrayed.

14. The apparatus according to claim 2, wherein said control means rewrites all printing data stored in said first storage means every scanning printing in the single-pass printing mode, and rewrites some of printing data stored in said second storage means every scanning printing in the multipass printing mode.

15. The apparatus according to claim 2, wherein
said first storage means stores printing data for discharging the first droplet amount of ink, and
said second storage means stores printing data for discharging the second droplet amount of ink.

16. The apparatus according to claim 15, wherein
the printhead comprises a nozzle array on which nozzles for discharging a third droplet amount of ink are arrayed, and
said first storage means stores printing data for discharging the first droplet amount of ink and printing data for discharging the third droplet amount of ink.

17. A printing apparatus which performs printing by using a printhead having a nozzle array on which nozzles for discharging dark ink are arrayed, and a nozzle array on which nozzles for discharging light ink are arrayed, comprising:
input means for inputting printing data containing a flag representing a type of printing mode from an external device;
scanning means for scanning the printhead in a direction different from a nozzle array direction;
a plurality of storage means for temporarily holding the printing data input by said input means;
control means for selecting storage means serving as a holding destination for the printing data from said plurality of storage means on the basis of the flag in the printing data that represents the type of printing mode, and storing the printing data in said selected storage means; and
transfer means for transferring the printing data stored in said storage means to the printhead.

18. A printing apparatus which performs printing by using a printhead having a nozzle array on which nozzles with a first orifice diameter are arrayed, and a nozzle array on which nozzles with a second orifice diameter are arrayed, comprising:
input means for inputting printing data containing a flag representing a type of printing mode from an external device;
scanning means for scanning the printhead in a direction different from a nozzle array direction;
a plurality of storage means for temporarily holding the printing data input by said input means;
control means for selecting storage means serving as a holding destination for the printing data from said plurality of storage means on the basis of the flag in the printing data that represents the type of printing mode, and storing the printing data in said selected storage means; and
transfer means for transferring the printing data stored in said storage means to the printhead.
